(19) United States
(12) Patent Application Publication
(10) Pub. No.: US 2021/0197916 A1
(43) Pub. Date: Jul. 1, 2021

(54) VEHICLE LEANING MECHANISM WITH GRAVITY-ASSIST SELF-RIGHTING MEANS

(71) Applicant: James Lin, Scarsdale, NY (US)

(72) Inventor: James Lin, Scarsdale, NY (US)

(21) Appl. No.: 17/132,993

(22) Filed: Dec. 23, 2020

Related U.S. Application Data
(60) Provisional application No. 62/953,947, filed on Dec. 27, 2019.

(51) Int. Cl. B62K 5/10; B62K 5/06

(52) U.S. Cl. CPC B62K 5/10; B62K 5/06

(57) ABSTRACT

A multi-tracked segmented narrow-body vehicle where one segment leans relative to the other non-leaning segment in order to stabilize the vehicle during turning maneuvers. The vehicle segments and leaning dynamics are defined by a rotating structural swivel pivot, positioning guide track(s), and positioning locating wheel assembly (or assemblies) that define the vehicle leaning behavior. The swivel pivot, positioning guide track(s), and positioning locating wheel assembly (or assemblies) also manage the vehicle center of gravity to create gravitational potential energy and a gravitational torque during the vehicle leaning to automatically self-right and recover the vehicle from a dynamic leaning configuration to a stable upright configuration without additional force inputs.

### RELATED U.S. APPLICATION DATA

Provisional application No. 62/953,947 filed on Dec. 27, 2019.

### CROSS-REFERENCES

This application claims the benefit under 35 U.S.C. § 119 (e) of the priority of U.S. Provisional Patent Application No. 62/953,947, filed on Dec. 27, 2019, the entirety of which is hereby incorporated by reference for all purposes.

### FEDERALLY SPONSORED RESEARCH

None

### BACKGROUND

### Prior Art

The following is a tabulation of some prior art that presently appears relevant:

| | | |
|---|---|---|
| Patent Number | Issue Date | Patentee |

U.S. PATENT DOCUMENTS

| | | |
|---|---|---|
| U.S. Pat. No. 2,819,093 | 1958 Jan. 7 | Geiser |
| U.S. Pat. No. 2,878,032 | 1959 Mar. 17 | Hawke |
| U.S. Pat. No. 3,504,934 | 1970 Apr. 7 | Wallis |
| U.S. Pat. No. 3,583,727 | 1971 Jun. 8 | Wallis |
| U.S. Pat. No. 3,605,929 | 1971 Sep. 20 | Rolland |
| U.S. Pat. No. 3,931,989 | 1976 Jan. 13 | Nagamitsu |
| U.S. Pat. No. 3,938,609 | 1976 Feb. 17 | Kensaku |
| U.S. Pat. No. 3,995,875 | 1976 Dec. 7 | Wada |
| U.S. Pat. No. 4,065,144 | 1977 Dec. 27 | Winchell |
| U.S. Pat. No. 4,237,995 | 1980 Dec. 9 | Pivar |
| U.S. Pat. No. 4,316,520 | 1982 Feb. 23 | Yamamoto |
| U.S. Pat. No. 4,325,565 | 1982 Apr. 20 | Winchell |
| U.S. Pat. No. 4,423,795 | 1984 Jan. 3 | Winchell |
| U.S. Pat. No. 4,437,535 | 1984 Mar. 20 | Winchell |
| U.S. Pat. No. 4,484,648 | 1984 Nov. 27 | Jephcott |
| U.S. Pat. No. 4,634,137 | 1987 Jan. 6 | Cocksedge |
| U.S. Pat. No. 4,740,004 | 1988 Apr. 26 | McMullen |
| U.S. Pat. No. 4,921,263 | 1990 May 1 | Patin |
| U.S. Pat. No. 4,974,863 | 1990 Dec. 4 | Patin |
| U.S. Pat. No. 5,040,812 | 1991 Aug. 20 | Patin |
| U.S. Pat. No. 5,240,267 | 1993 Aug. 31 | Owsen |
| U.S. Pat. No. 5,437,467 | 1995 Aug. 1 | Patin |
| U.S. Pat. No. 5,730,453 | 1998 Mar. 24 | Owsen |
| U.S. Pat. No. 5,765,846 | 1998 Jun. 16 | Braun |
| U.S. Pat. No. 6,062,581 | 2000 May 16 | Stites |
| U.S. Pat. No. 6,328,121 | 2001 Dec. 11 | Woodbury |
| U.S. Pat. No. 6,328,125 | 2001 Dec. 11 | Van Den Brink |
| U.S. Pat. No. 6,572,130 | 2003 Jun. 3 | Greene |
| U.S. Pat. No. 6,863,288 | 2005 Mar. 8 | Van Den Brink |
| U.S. Pat. No. 7,073,806 | 2006 Jul. 11 | Bagnoli |
| U.S. Pat. No. 7,100,727 | 2006 Sep. 5 | Patin |
| U.S. Pat. No. 7,308,963 | 2007 Dec. 18 | Patin |
| U.S. Pat. No. 7,343,997 | 2008 Mar. 18 | Matthies |
| U.S. Pat. No. 7,543,829 | 2009 Jul. 9 | Barnes |
| U.S. Pat. No. 7,571,787 | 2009 Aug. 11 | Saiki |
| U.S. Pat. No. 7,591,337 | 2009 Sep. 22 | Suhre |
| U.S. Pat. No. 7,600,596 | 2009 Oct. 13 | Van Den Brink |
| U.S. Pat. No. 7,665,749 | 2010 Feb. 23 | Wilcox |
| U.S. Pat. No. 7,850,180 | 2010 Dec. 14 | Wilcox |
| U.S. Pat. No. 8,292,315 | 2012 Oct. 23 | Pelkonen |
| U.S. Pat. No. 8,595,660 | 2013 Dec. 3 | Hsu |
| U.S. Pat. No. 8,613,340 | 2013 Dec. 24 | Hsu |
| U.S. Pat. No. 8,668,037 | 2014 Mar. 11 | Shinde |
| U.S. Pat. No. 8,762,003 | 2014 Jun. 24 | Mercier |
| U.S. Pat. No. 8,781,684 | 2014 Jul. 15 | Bruce |
| U.S. Pat. No. 9,045,015 | 2015 Jun. 2 | Spahl |
| U.S. Pat. No. 9,090,281 | 2015 Jul. 28 | Spahl |
| U.S. Pat. No. 9,145,168 | 2015 Sep. 29 | Spahl |
| U.S. Pat. No. 9,248,857 | 2016 Feb. 2 | Spahl |
| U.S. Pat. No. 9,283,989 | 2016 Mar. 15 | Spahl |
| U.S. Pat. No. 9,327,725 | 2016 May 3 | Anderfaas |
| U.S. Pat. No. 9,487,234 | 2016 Nov. 8 | Matthies |
| U.S. Pat. No. 9,731,785 | 2017 Aug. 15 | Liu |
| U.S. Pat. No. 9,821,620 | 2017 Nov. 21 | Saeger |
| U.S. Pat. No. 9,845,129 | 2017 Dec. 19 | Simon |
| U.S. Pat. No. 9,925,843 | 2018 Mar. 27 | Spahl |
| U.S. Pat. No. 9,932,087 | 2018 Apr. 3 | Alvarez-Icaza |
| U.S. Pat. No. 10,023,019 | 2018 Jul. 17 | Spahl |
| U.S. Pat. No. 10,076,939 | 2018 Sep. 18 | Simon |
| U.S. Pat. No. 10,106,218 | 2018 Oct. 23 | Hsu |
| U.S. Pat. No. 10,131,397 | 2018 Nov. 20 | Page |
| U.S. Pat. No. 10,144,474 | 2018 Dec. 4 | Matthies |
| U.S. Pat. No. 10,501,119 | 2019 Dec. 10 | Doerksen |

FOREIGN PATENT DOCUMENTS

| | |
|---|---|
| Canada 2302684 | 2006 Sep. 12 |
| Europe EP3375647 | 2018 Sep. 19 |
| Netherlands 2022123 | 2020 Jul. 1 |

### FIELD OF THE INVENTION

This disclosure is related to systems and methods to automatically or semi-automatically control and right a leaning multi-tracked vehicle.

### BACKGROUND OF THE INVENTION

This relates to tilting/leaning vehicles and the means in which they right themselves.

Narrow-bodied vehicles have the advantage of low frontal area for good aerodynamic performance. Also, in congested urban environments, their compact narrow bodies allow for better maneuverability and handling.

However, narrow-bodied vehicles are relatively unstable in turning maneuvers since their narrow widths do not effectively counter turn-induced centripetal forces that tend to overturn them. Therefore, in order to compensate, they must lean into the turns to overcome such forces.

Single-tracked narrow bodied vehicles (i.e.—2-wheel bicycles, scooters, motorcycles and like vehicles) lean into turns to counter these centripetal forces. However, such vehicles' single-tracked configurations are not inherently stable since with only two wheels (points of contact) on the ground, they have less traction than other vehicle types and cannot stand upright (and are unstable) at rest (i.e.—a kickstand is needed to prevent falling over).

By comparison, multi-tracked (i.e. 3+ wheels) narrow-bodied vehicles have the advantage over single-tracked vehicles in that they have at least 50% more tire contact area (+one wheel over a two-wheeled vehicle) and with three+ points of wheel contact are inherently stable at rest.

The design challenge with leaning multi-tracked narrow-bodied vehicles is how to effectively control the vehicle leaning in a simple, cost effective manner.

Multi-tracked leaning vehicles are generally configured in two ways—depending on their method of leaning.

The first configuration is where the vehicle leaning is controlled by a specially-designed suspension system that serves a dual purpose—control road irregularities (as a normal vehicle suspension) and control the vehicle leaning. U.S. Pat. Nos. 4,921,263, 7,073,806, 7,591,337, 8,762,003, 9,283,989 and 10,501,119 are some examples of this configuration.

The second configuration is where the vehicle body is separated into two (2) linked segments where one segment leans relative to the other. Here, the vehicle leaning is controlled by a special linkage system connecting the two vehicle segments. U.S. Pat. Nos. 2,819,093, 3,504,934, 3,605,929, 4,423,795, and 6,328,125 are examples of this vehicle configuration.

Despite the design advantages of narrow bodied vehicles, the impediments to commercial adoption of the prior art is reliance on complex mechanical and/or electronic mechanisms to ensure vehicle stability—first leaning the vehicle into a turn and then righting and recovering the vehicle to a neutral, upright resting position.

Complex and expensive vehicle leaning systems have been major technical and economic hurtles to the adoption of narrow-bodied multi-tracked vehicles.

U.S. Pat. Nos. 4,921,263, 5,040,812, 9,045,015 and 9,283,989 offer the possibility that gravity itself can be a much simpler and cheaper method to stabilize and automatically return a leaning vehicle to its upright, stable resting state.

Therefore, the present disclosure is a novel and mechanically simple leaning and stabilization system that primarily uses gravity to stabilize and self-right linked leaning and non-leaning segmented narrow-bodied vehicles.

### SUMMARY OF THE INVENTION

Utilizing gravity, the present leaning system disclosure describes the following advantages for a multi-tracked “leaning vehicle” (or simply “vehicle”):
1) It is very simple mechanically, consisting of only two (2) primary moving parts—a structural swivel pivot and a positioning locating wheel guided along a companion positioning guide track. This simplicity has the potential to dramatically lower the cost of vehicle leaning systems compared to the prior art, thus enabling practical commercial adoption.
2) The present disclosure is primarily mechanical and thus low cost and adoptable by the full range of leaning vehicle types—from the simplest, lightest and least expensive leaning vehicles (i.e.—three-wheel kick scooters) to the most complex, heaviest and expensive powered three-wheel car-type multi-passenger leaning vehicles.
3) By its nature, this gravity-based stabilization system disclosure will automatically compensate for added payload and passenger weight. As long as vehicle's center-of-gravity (CG) position is managed and located correctly (as will be shown in this disclosure), the vehicle will actually become more stable the heavier it is loaded (with payload and passenger weight).

In the preferred embodiment, the swivel pivot is the main structural element connecting a leaning segment and a non-leaning segment of the leaning vehicle. In addition to structurally connecting the leaning segment and non-leaning segments of the leaning vehicle, the swivel pivot also allows the leaning segment and non-leaning segment to rotate independently along included parallel longitudinal axes.

To control the leaning angle of the vehicle, a single positioning locating wheel engaging in its companion positioning guide track is located along the vertical axis, mid-width point of the leaning vehicle. Trigonometric relationships govern the kinematic behavior of the various vehicle elements:
1) The distances between the swivel pivot/leaning segment rotating axis, swivel pivot/non-leaning segment rotating axis, and the positioning locating wheel (engaging within the positioning guide track).
2) The distance the positioning locating wheel travels vertically along the positioning guide track while the swivel pivot rotates through its full angular travel.
3) The location of the empty (unloaded—no cargo or passengers) leaning vehicle center of gravity.
4) The location of the fully loaded (+passengers+cargo) leaning vehicle center of gravity.
5) The point where the dynamic turning centripetal force will act on the vehicle.
6) The points where additional manually or powered “moment forces” can induce the vehicle to lean.

In a second embodiment, a single telescoping piston replaces the single vertically oriented positioning locating wheel and a piston housing replaces the vertically oriented positioning guide track. The new piston and piston housing combination replaces and duplicates the original positioning locating wheel/positioning guide track combination to control the leaning angle of the vehicle.

In a third embodiment, instead of a single positioning locating wheel and positioning guide track combination along the vehicle's vertical axis controlling the vehicle lean, two (2) horizontally-placed positioning locating wheel and positioning guide track combinations are positioned on the leaning vehicle horizontal axis to control the vehicle leaning angle.

In a fourth embodiment, the positioning guide tracks on each of the two (2) horizontal positioning locating wheel/positioning guide track combinations are tilted at measured angles. Angling the positioning guide tracks allows moment forces to induce the vehicle to lean.

Finally, in a fifth embodiment, the vehicle's upright non-leaning resting “stance” is sloped at an upwards angle lengthwise so that at full leaning angle, a constant ground clearance is maintained along the vehicle's entire underside length.

### BRIEF DESCRIPTION OF THE DRAWINGS

FIG. 1 shows a left-front isometric view of an example multi-tracked leaning vehicle (“vehicle”—here a small kick-scooter) in the upright, stable and resting configuration.

FIG. 2 shows the left-front isometric view of the vehicle in the full leaning configuration.

FIG. 3 shows the left-rear isometric view of the vehicle in the upright resting configuration.

FIG. 4 shows the left-rear isometric view of the vehicle in the full leaning configuration.

FIG. 5 shows the close-up of the left rear isometric view of the vehicle in the upright resting configuration.

FIG. 6 shows the close-up of the left rear isometric view of the vehicle in the full leaning configuration.

FIG. 7 shows the “exploded” (showing the various individual elements of the vehicle leaning system) close-up of the left rear isometric view of the vehicle in the upright resting configuration.

FIG. 8 shows the exploded close-up of the left rear isometric view of the vehicle in the full leaning configuration.

FIG. 9 shows the side view of the vehicle in a full leaning configuration—with all the wheels resting on the ground plane.

FIG. 10 shows the side view of the vehicle in a full leaning configuration—showing the increased height of the leaning vehicle segment (as shown by front wheel distance from the ground plane) versus the level non-leaning vehicle segment (with the vehicle held parallel to the ground plane).

FIG. 11 shows the rear view of the vehicle in the upright (leaning angle α=90) resting configuration.

FIG. 12 shows the rear view of the vehicle at the leaning angle α configuration.

FIG. 13 shows the rear close-up view of the vehicle in the upright (leaning angle α=90) resting configuration showing in detail the various parts of the leaning vehicle and their various trigonometric relationships.

FIG. 14 shows the rear close-up view of the vehicle in the leaning angle α configuration showing in detail the various parts of the vehicle and their trigonometric relationships.

FIG. 15 shows the rear close-up view of the vehicle in the leaning angle α configuration showing in detail parts of the vehicle and forces acting upon them. These are moment forces MF, centripetal force CF and up to two (2) gravity force moments. One, the center of gravity moment (vehicle) CGM(V) acts through the vehicle center of gravity CG(V). And if this particular vehicle is much smaller compared to its passenger+cargo load, a gravity force moment (load) CGM(L), acting through a separate load (passengers+cargo) center of gravity CG(L), must be managed separately since it is in a different location from the CG(V) as shown.

FIG. 16 shows a close-up left front isometric view of the vehicle's second embodiment in the upright (leaning angle α=90) resting configuration where the single positioning locating wheel/positioning guide track combination is replaced by a telescoping piston and piston housing assembly that performs the same function.

FIG. 17 shows a close-up left front isometric view of the second embodiment of the vehicle at the leaning angle α configuration where the single positioning locating wheel/positioning guide track combination is replaced by the telescoping piston and piston housing assembly that performs the same function.

FIG. 18 shows a close-up left rear isometric view of the second embodiment at the upright (leaning angle α=90) resting configuration where the single positioning locating wheel/positioning guide track combination is replaced by the telescoping piston and piston housing assembly that performs the same function.

FIG. 19 shows a close-up left rear isometric view of the second embodiment of the vehicle in the leaning angle α configuration where the single positioning locating wheel/positioning guide track combination is replaced by the telescoping piston and piston housing assembly that performs the same function.

FIG. 20 shows a close-up rear view of the second embodiment at the upright (leaning angle α=90) resting configuration where the single positioning locating wheel/positioning guide track combination is replaced by the telescoping piston and piston housing assembly that performs the same function.

FIG. 21 shows a close-up rear view of the second embodiment of the vehicle in the leaning angle α configuration where the single positioning locating wheel/positioning guide track combination is replaced by the telescoping piston and piston housing assembly that performs the same function.

FIG. 22 shows a close-up left front isometric view of the third embodiment at the upright (leaning angle α=90) resting configuration where starboard and port horizontal positioning locating wheel/positioning guide track combinations replace the original single vertical positioning locating wheel/positioning guide track combination.

FIG. 23 shows a close-up left front isometric view of the third embodiment at leaning angle α configuration where starboard and port horizontal positioning locating wheel/positioning guide track combinations replace the original single vertical positioning locating wheel/positioning guide track combination.

FIG. 24 shows a close-up left rear isometric view of the third embodiment at the upright (leaning angle α=90) resting configuration where starboard and port horizontal positioning locating wheel/positioning guide track combinations replace the original single vertical positioning locating wheel/positioning guide track combination.

FIG. 25 shows a close-up left rear isometric view of the third embodiment at the leaning angle α configuration where starboard and port horizontal positioning locating wheel/positioning guide track combinations replace the original single vertical positioning locating wheel/positioning guide track combination.

FIG. 26 shows a close-up rear view of the third embodiment at the upright (leaning angle α=90) resting configuration where starboard and port horizontal positioning locating wheel/positioning guide track combinations replace the original single vertical positioning locating wheel/positioning guide track combination.

FIG. 27 shows a close-up rear view of the third embodiment at the leaning angle α configuration where starboard and port horizontal positioning locating wheel/positioning guide track combinations replace the original single vertical positioning locating wheel/positioning guide track combination.

FIG. 28 shows a close-up left front isometric view of the fourth embodiment at the upright (leaning angle α=90) resting configuration where the starboard and port positioning guide tracks are specifically angled.

FIG. 29 shows a close-up left front isometric view of the fourth embodiment at the leaning angle α configuration where the starboard and port positioning guide tracks are specifically angled.

FIG. 30 shows a close-up left rear isometric view of the fourth embodiment at the upright (leaning angle α=90) resting configuration where the starboard and port positioning guide tracks are specifically angled.

FIG. 31 shows a close-up left rear isometric view of the fourth embodiment at the leaning angle α configuration where the starboard and port positioning guide tracks are specifically angled.

FIG. 32 shows a close-up rear view of the fourth embodiment at the upright (leaning angle α=90) resting configuration where the starboard and port positioning guide tracks are specifically angled.

FIG. 33 shows a close-up rear view of the fourth embodiment at the leaning angle α configuration where the starboard and port positioning guide tracks are specifically angled.

FIG. 34 shows the left view of the fifth embodiment where the vehicle is in a sloped stance in the upright and stable resting α=90 configuration.

FIG. 35 shows the left view of the fifth embodiment where the vehicle is in a sloped stance in the leaning angle α configuration.

### DETAILED DESCRIPTION

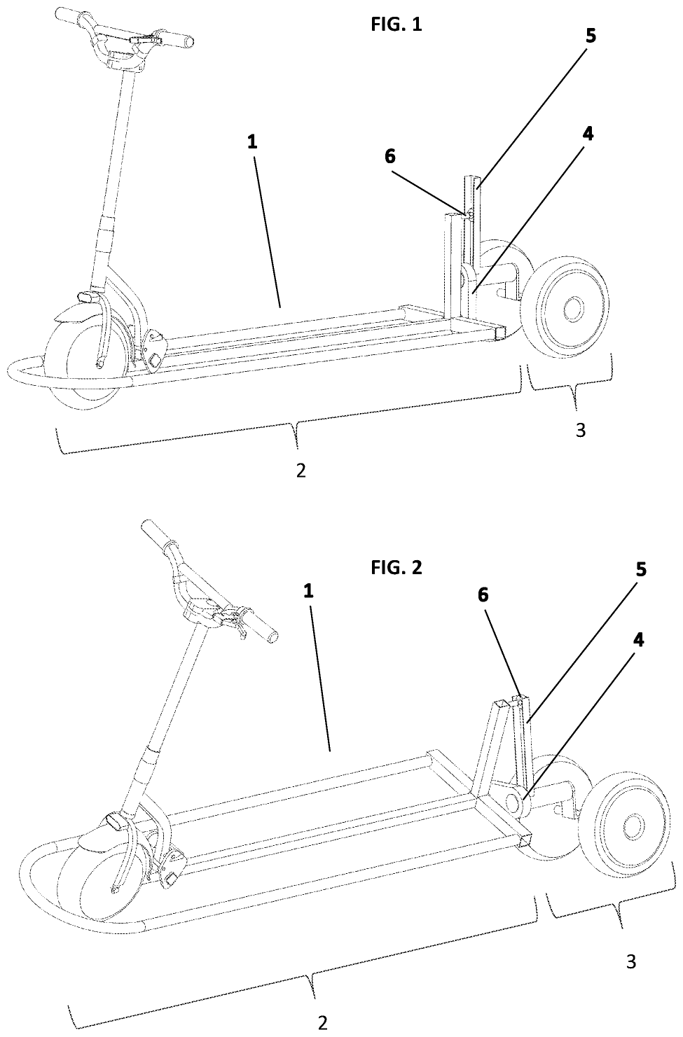

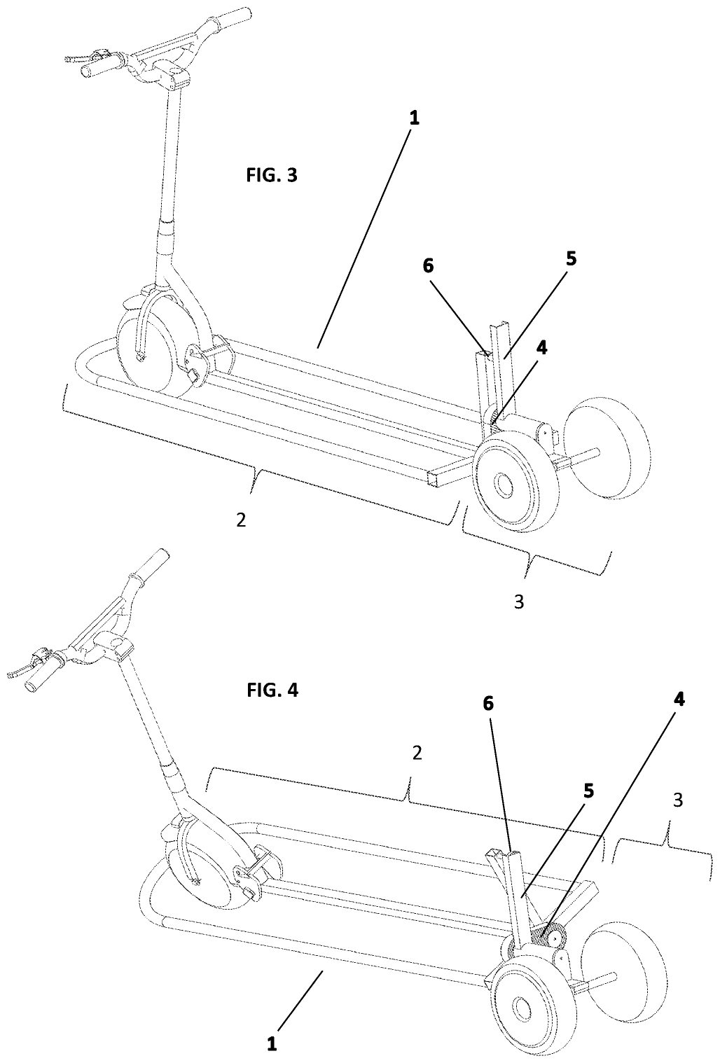

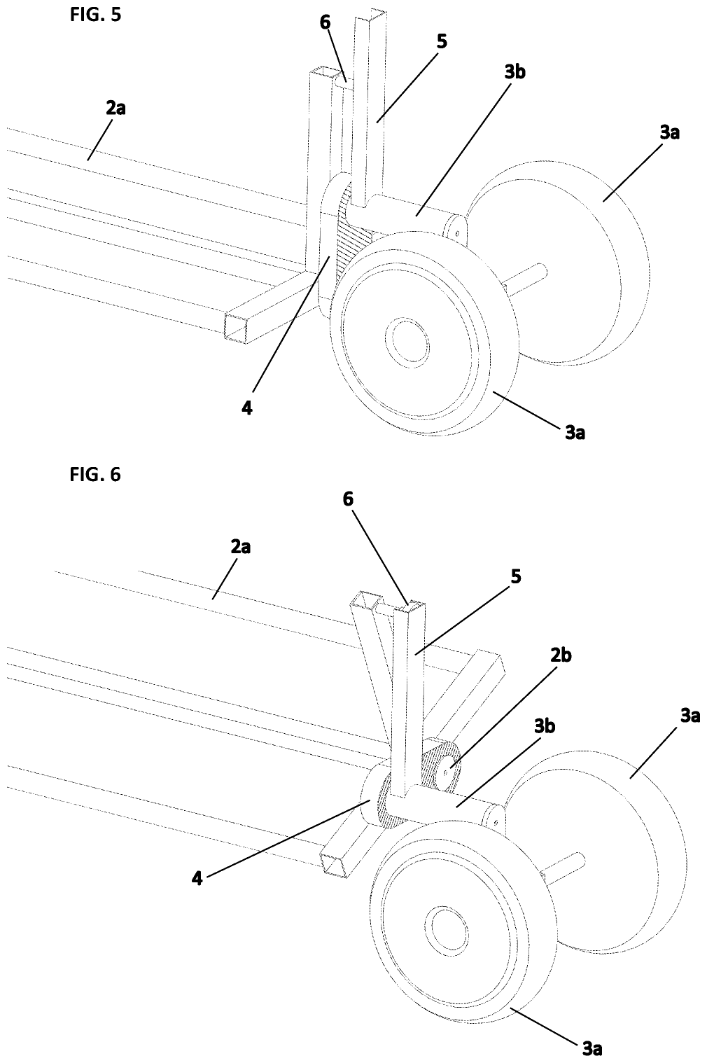

FIGS. 1-4 shows the preferred embodiment of an example multi-track leaning vehicle 1—a small kick scooter-type vehicle (powered or unpowered). The vehicle 1 comprises of two segments—a forward leaning segment 2 and a rear non-leaning segment 3.

Note in alternative embodiments, the vehicle segments can be reversed where the leaning segment 2 is at the rear of the vehicle while the non-leaning segment 3 is at the front.

As shown in FIGS. 1-4, the leaning segment 2 is connected to the non-leaning segment 3 structurally via a swivel pivot 4. “Structurally” because swivel pivot 4 is responsible for absorbing all the structural stresses of connecting the vehicle 1's leaning segment 2 and non-leaning segment 3 while allowing leaning segment 2 and non-leaning segment 3 to rotate and lean independently of each other via the included swivel pivot 4's parallel axes.

Also shown in FIGS. 1-4 are the other primary elements of this disclosure's leaning system. Positioning guide track 5 is mounted to the non-leaning segment 3 at its mid-width point and on a vertical axis as shown. Positioning locating wheel 6 is mounted to the leaning section 2 also at its mid-width point and on a vertical axis as shown.

Alternatively, in another embodiment, the mounting positions of positioning guide track 5 and positioning locating wheel 6 are reversed so that positioning guide track 5 is now mounted on leaning segment 2 and positioning locating wheel 6 is mounted to the non-leaning segment 3. In this embodiment, the functionality of positioning locating wheel 6's engagement to position guide track 5 will remain the same as the preferred embodiment.

FIG. 5 shows a left rear isometric view of vehicle 1 in the upright resting stable configuration. In addition to the elements already identified, note the addition of leaning segment frame 2a, non-leaning segment rotating axis 3b and non-leaning segment wheels 3a (both left and right).

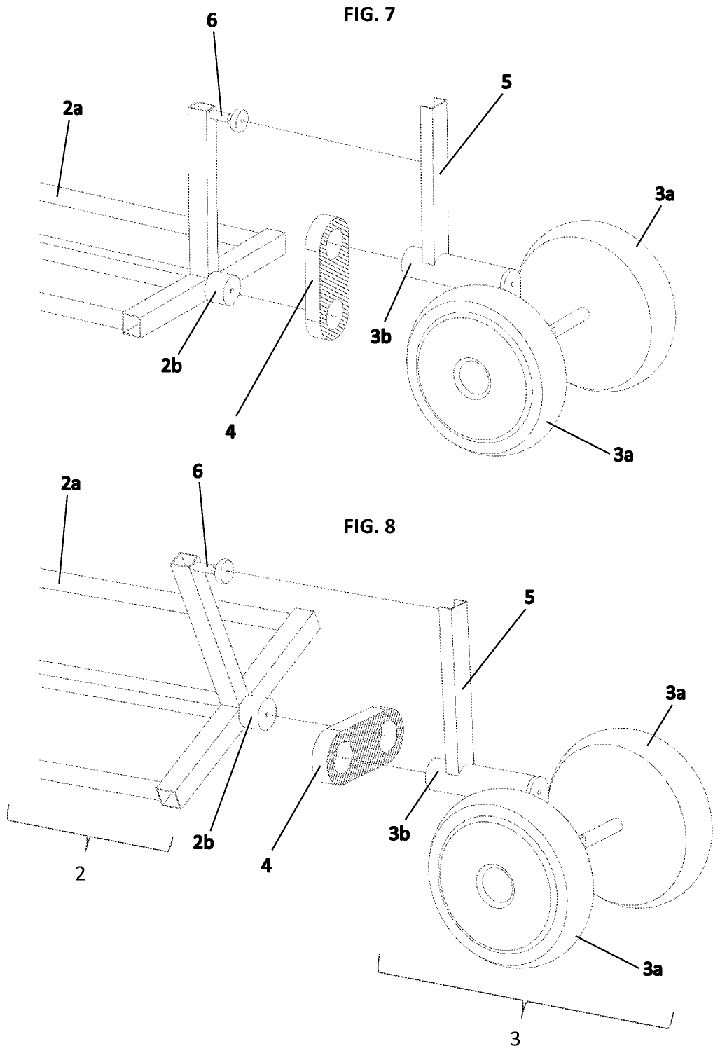

FIG. 6 shows a left rear close-up isometric view of vehicle 1 in the leaning configuration. Note how frame 2a is connected to swivel pivot 4 via leaning segment rotating axis 2b. Then the combination of swivel pivot 4's rotation (here counterclockwise) and positioning locating wheel 6's tracking within positioning guide track 5 leans frame 2a at a determined angle α (see FIG. 12). Note how the swivel pivot 4 is connected to the non-leaning segment rotating axis 3b and leaning segment rotating axis 2b to connect all the separate elements of vehicle 1 together.

FIG. 7 and FIG. 8 show the “exploded” views of FIG. 5 and FIG. 6 respectively. Note especially how leaning segment rotating axis 2b connects to swivel pivot 4 which in turn connects to the non-leaning segment rotating axis 3b. In addition, note how positioning locating wheel 6 fits into and tracks along positioning guide track 5.

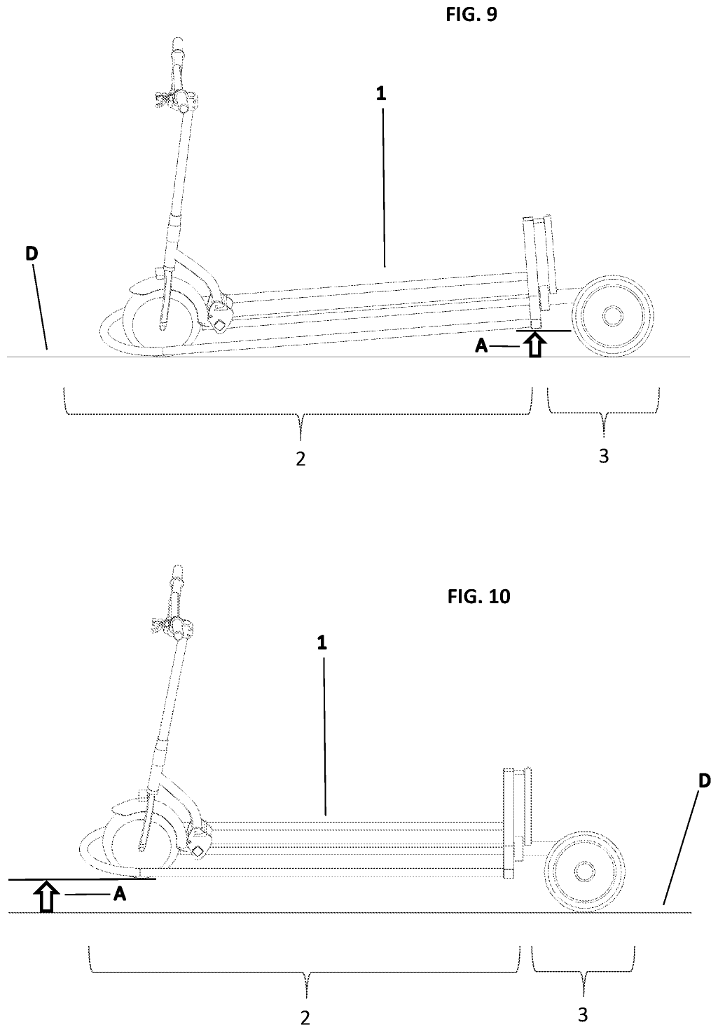

FIG. 9 shows the left view of the vehicle 1 in a leaning configuration. A characteristic of the present disclosed leaning system is that it lifts the vehicle 1 upwards as it leans. This has at least two (2) desirable effects. First, raising the vehicle 1 will create gravitational potential energy and an accompanying gravity righting moment to self-right it. Secondly, raising the vehicle 1 will create a constant ground clearance A widthwise on the underside of vehicle 1 as it leans.

In FIG. 9, with all the wheels contacting ground plane D, the vehicle 1 will adopt a “slope-down” stance as it leans. However, as shown in FIG. 10, holding the vehicle 1 level, it can be seen that the leaning segment 2's front wheel has been raised by a height A (measured against ground plane D) while leaning.

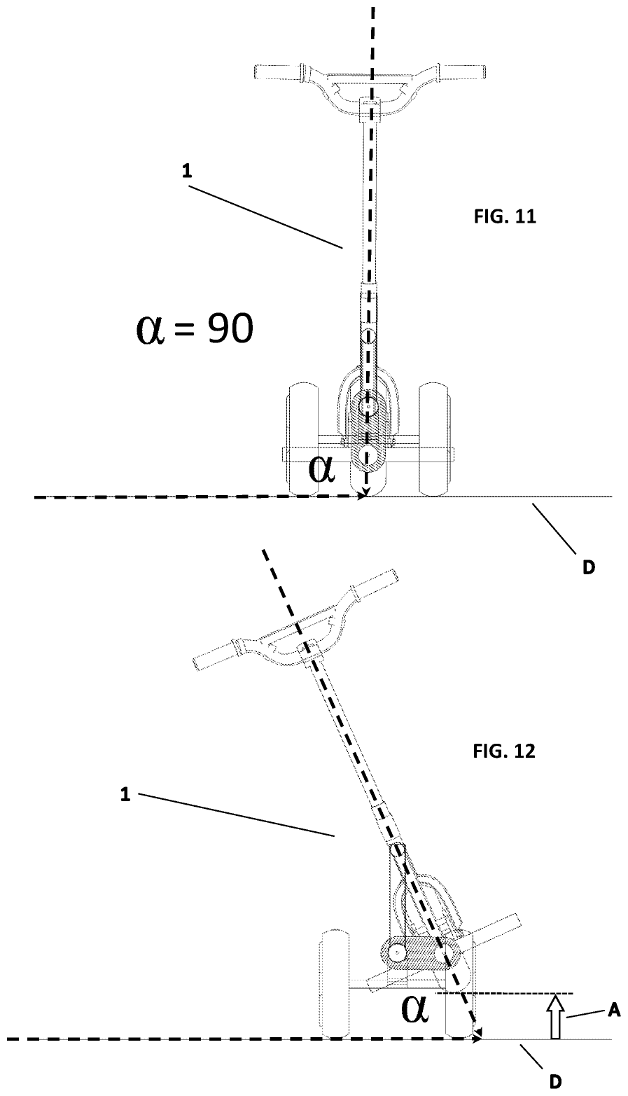

FIG. 11 shows the rear view of vehicle 1 in the upright stable resting configuration (leaning angle α=90).

FIG. 12 shows the rear view of vehicle 1 with a leaning angle α. Note the resultant front wheel raised by height A (measured from the bottom of the front wheel to ground plane D) as the vehicle 1 is at a leaning angle α.

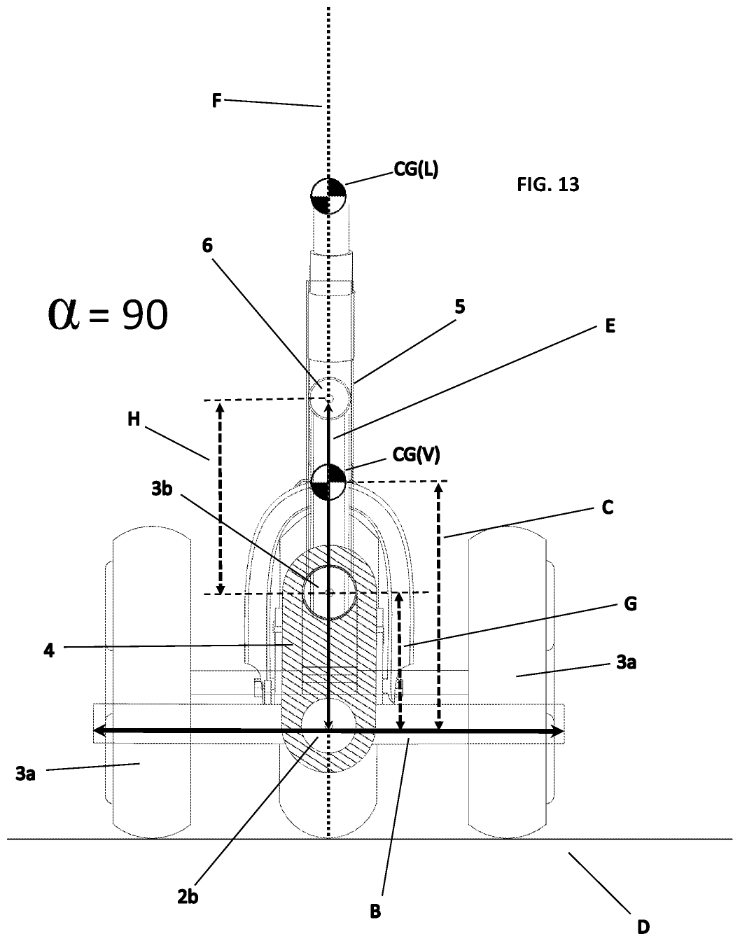

FIG. 13 shows the rear close-up view of vehicle 1 in the upright stable resting configuration (leaning angle α=90) with the elements of this disclosure's leaning system and all its associated trigonometric relationships. Swivel pivot 4 is shown with its top rotating axis connected to the non-leaning segment rotating axis 3b and its bottom rotating axis connected to the leaning segment rotating axis 2b. Positioning locating wheel 6, positioning guide track 5 and left and right wheels 3a are the other vehicle 1 elements shown.

Note in FIG. 13 that there are two (2) “center of gravities” shown. The first is a center of gravity-vehicle CG(V) (vehicle only—no passengers+cargo). The second is a center of gravity-loads CG(L) (passenger+cargo load only).

Since the disclosed leaning system relies on gravity-induced forces, managing the movement and position of the vehicle 1's center of gravity is key to its function. Ideally, the vehicle 1's center of gravity's position does not change between loaded and unloaded configurations. This should not be an issue if vehicle 1's configuration is large enough and the vehicle 1 CG(V) and CG(L) are fixed in approximately the same location in all leaning and non-leaning configurations.

However as shown in FIG. 13, in very small vehicles (as in the example kick scooter), its CG(V) will be much smaller and lower than the loaded CG(L).

In this circumstance, locating the CG(V) properly will self-right the empty (unloaded) vehicle 1. The CG(L) is then separately managed to ensure the vehicle 1 rights itself when loaded with any passengers and cargo (as will be shown).

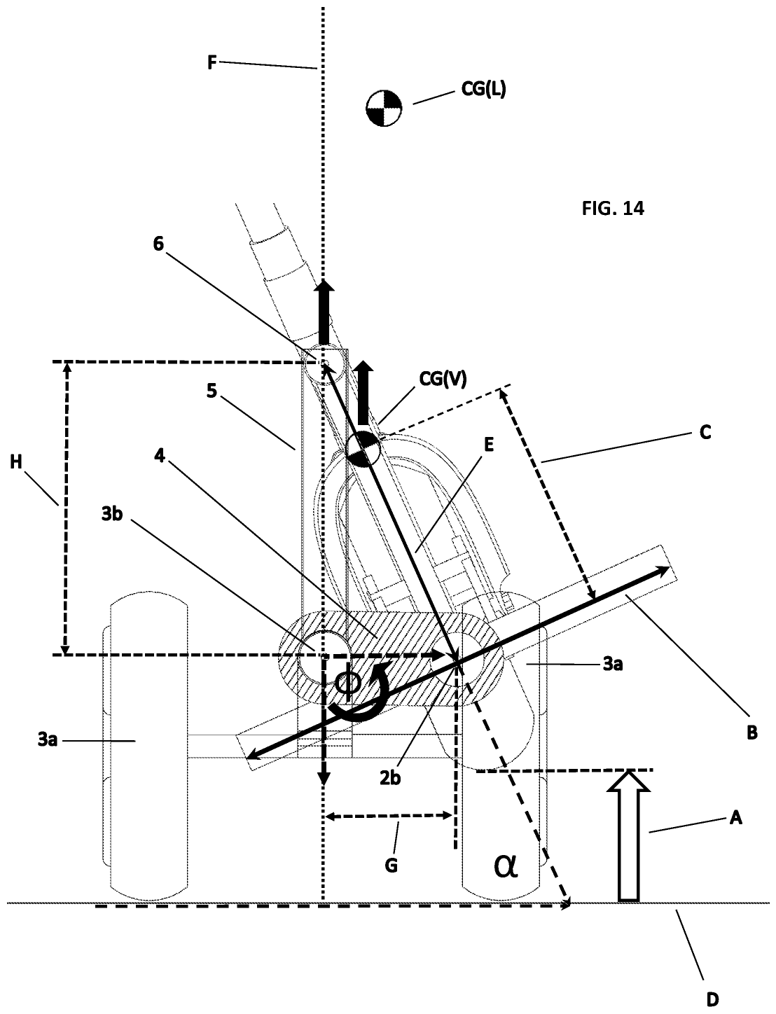

FIG. 13 and FIG. 14 shows the following trigonometric relationships during vehicle 1 non-leaning (vehicle 1 leaning angle α=90) and leaning (vehicle 1 leaning angle α) configurations respectively:
A—the distance the leaning segment 2's front wheel lifts off the ground plane D for the given leaning angle α.
B—the width of vehicle 1.
C—the distance from the leaning segment axis 2b to center of gravity-vehicle CG(V).
D—the ground plane of vehicle 1.
E—the mid-width centerline of leaning segment 2 and also the distance from leaning segment rotating axis 2b to positioning locating wheel 6.
F—the mid-width centerline of non-leaning segment 3.
G—the distance between the leaning segment rotating axis 2b and the non-leaning segment rotating axis 3b in the swivel link 4.
H—the distance between the non-leaning segment rotating axis 3b to position locating wheel 6.

FIG. 14 shows the rear close-up view of vehicle 1 as swivel pivot 4 rotates counterclockwise (via non-leaning segment rotating axis 3b) to a swivel pivot angle ϕ to create a vehicle 1 leaning angle α configuration with elements of this disclosure's leaning system and all its associated trigonometric relationships. While many other trigonometric relationships can be derived, several basic ones can be calculated when swivel pivot 4 rotates ϕ=90 degrees counterclockwise via non-leaning segment rotating axis 3b as shown:

E²=G²+H²

Cosine α=G/E

Sine α=H/E

Tangent α=H/G

In addition, note that positioning locating wheel 6 rises vertically along the positioning guide track 5 as swivel pivot 4 rotates via non-leaning segment rotating axis 3b. Positioning locating wheel 6, in combination with swivel pivot 4, defines the leaning segment 2 leaning angle α when swivel pivot 4 rotates to swivel pivot angle ϕ. Note also the center of gravity-vehicle CG(V), being fixed along the mid-width centerline E, also rises. Raising the CG(V) will create gravitational potential energy that can be used to self-right the vehicle 1.

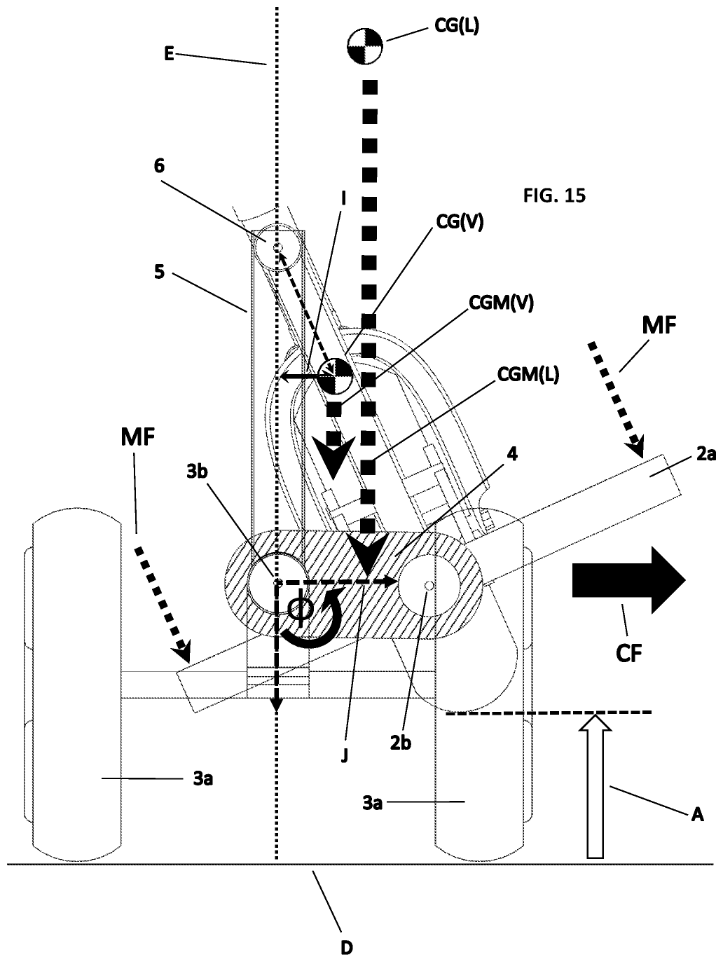

FIG. 15 shows the various forces that are acting and/or can act on the leaning vehicle 1 shown in FIG. 14. The center of gravity-vehicle CG(V), as located by the leaning segment 2, and acting through a virtual lever arm I, creates a center of gravity-vehicle moment CGM(V) that tends to right and return the vehicle 1 to its stable upright position.

As previously stated, if the vehicle 1 is large enough, only the CG(V) controls. However for small-sized vehicle 1's (like the example kick-scooter), the center of gravity-loads (the mass of passenger+cargo) CG(L) is much greater than the CG(V) (since the scooter is very small). In this case, the CG(L) must be independently managed (i.e.—by shifting body weight left or right) so it will, acting through a virtual lever arm J, create a righting center of gravity-loads moment CGM(L). As a result, the combined CGM(V) and CGM(L) moments will act to self-right the vehicle 1 via gravity.

Also as shown in FIG. 15, during a dynamic turn, a centripetal force CF will act on the leaning segment 2 of the vehicle 1. This CF will tend to overturn the vehicle 1 unless balanced by the combined center of gravity moments CGM(L) and CGM(V). Once the vehicle 1 turn is complete, the CGM(L) and CGM(V) combination will automatically self-right the vehicle 1.

Finally additional artificially induced moment forces MF (either human induced or other means) can act on either side of the vehicle 1 to lean the leaning segment 2 as needed.

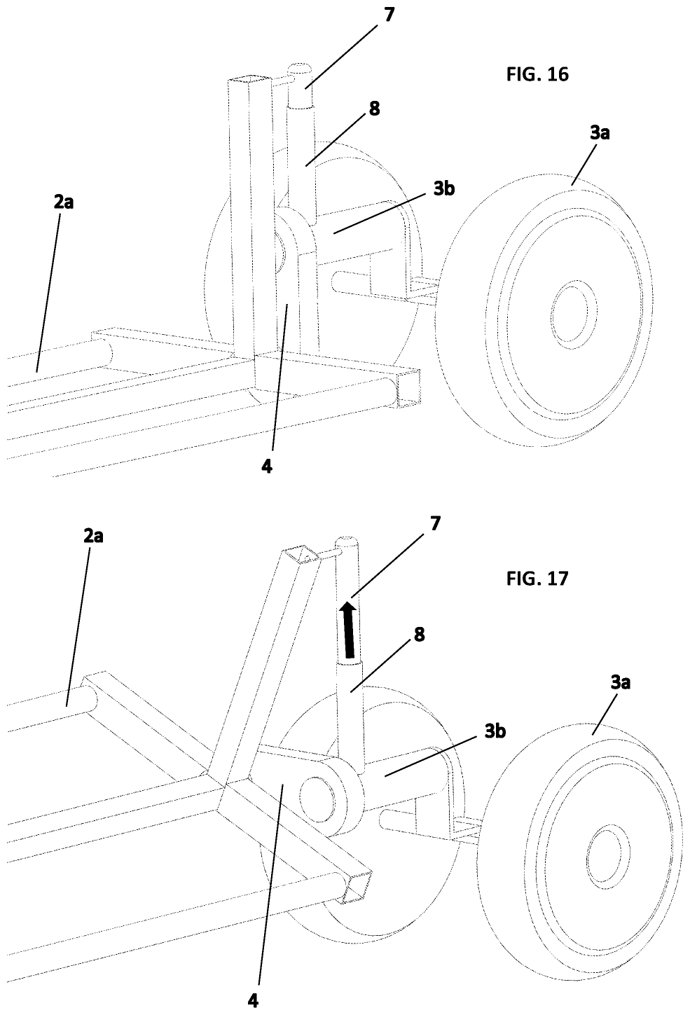

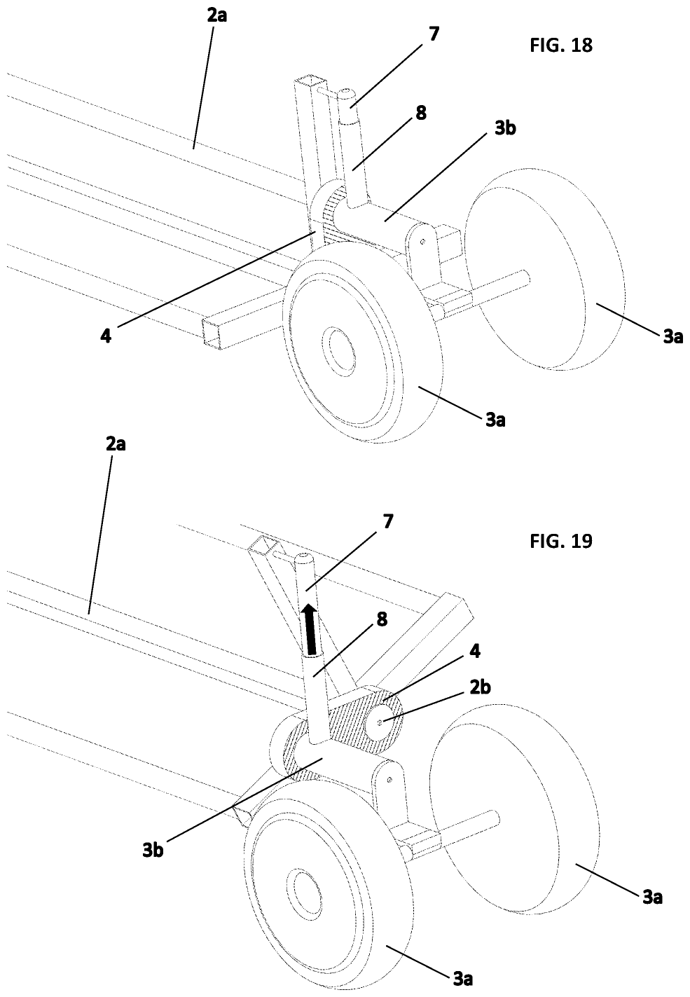

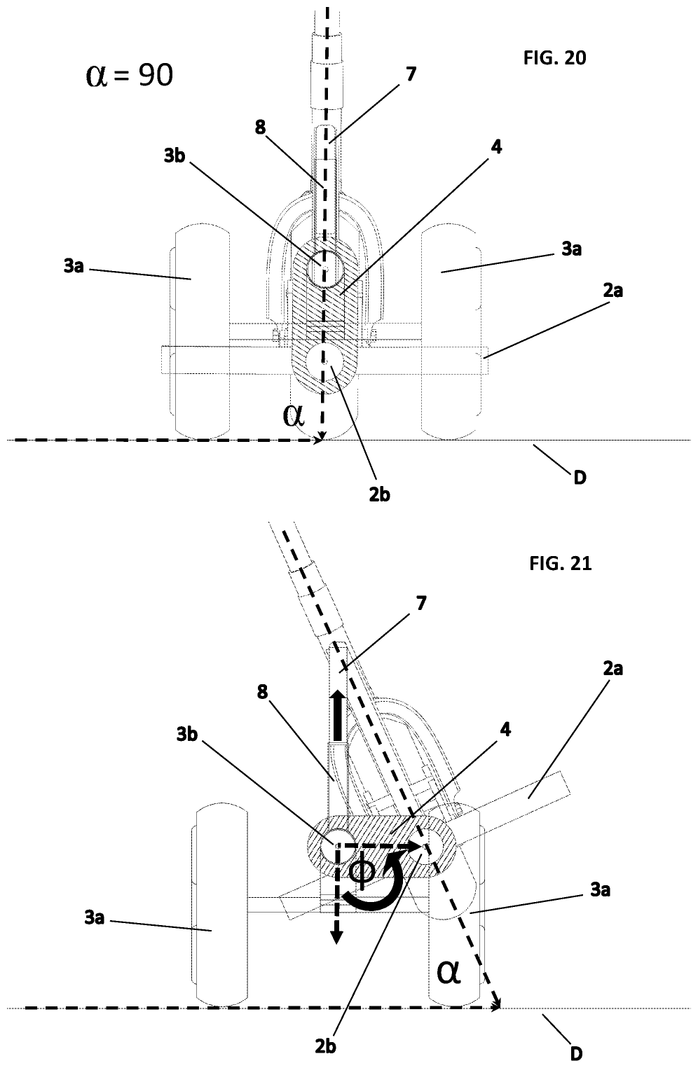

FIGS. 16, 18, and 20 show various views of the second embodiment of the present disclosure by replacing the single central-vertical positioning locating wheel 6 with a sliding piston 7 and the positioning guide track 5 with a piston housing 8 at the vehicle 1 leaning angle α=90 position.

FIGS. 17, 19, and 21 show various views of the second embodiment of the present disclosure by replacing the single central-vertical positioning locating wheel 6 with the sliding piston 7 and the positioning guide track 5 with the piston housing 8 at the vehicle 1 leaning angle α.

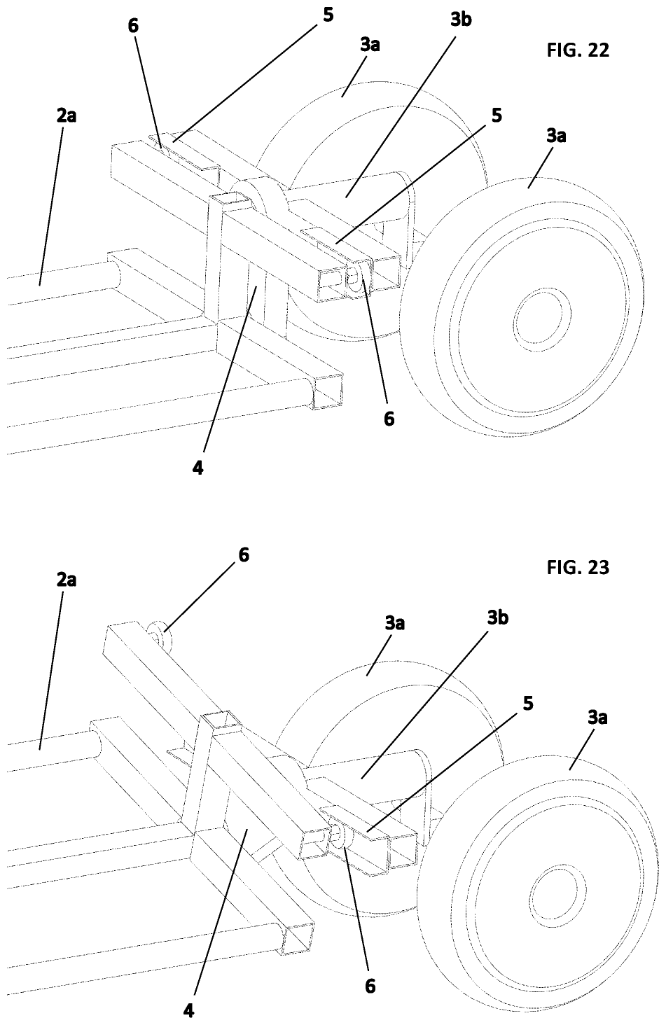

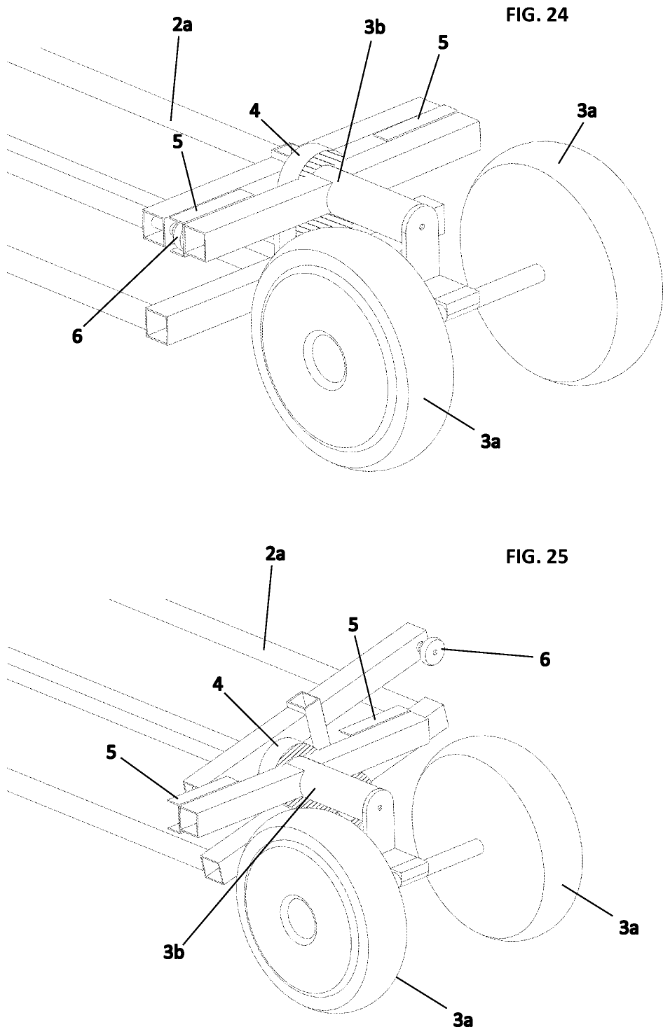

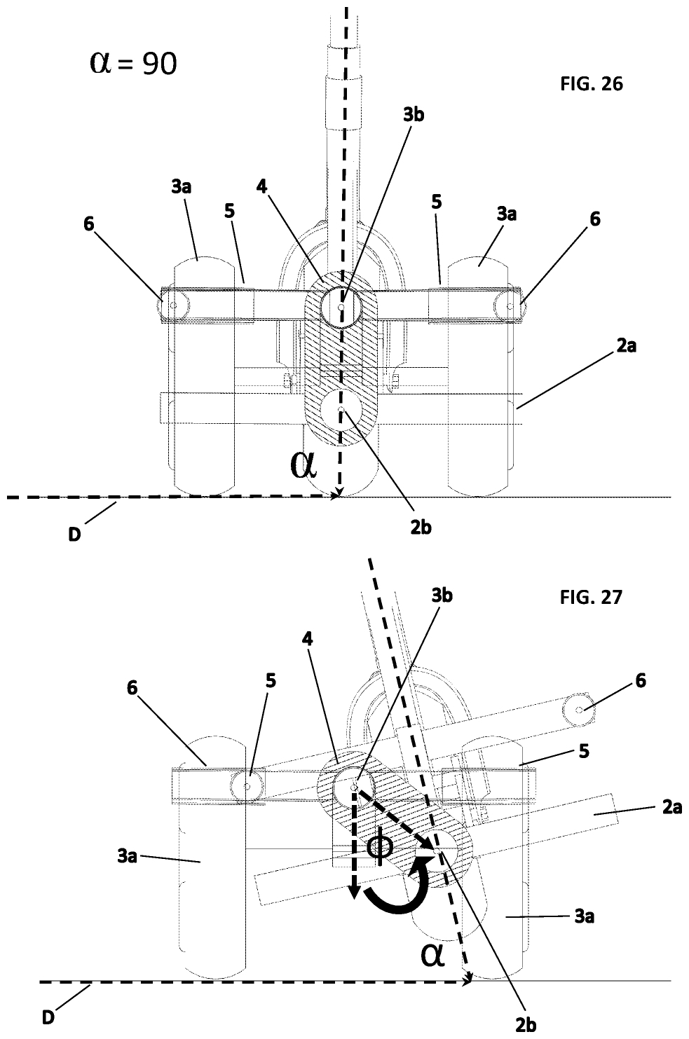

FIGS. 22, 24, and 26 show various views of the third embodiment of the present disclosure replacing the single central-vertical positioning locating wheel 6/positioning guide track 5 combination with horizontal starboard and port positioning locating wheel 6/positioning guide track 5 combinations at the upright stable vehicle 1 leaning angle α=90 position.

FIGS. 23, 25, and 27 show various views of the third embodiment of the present disclosure replacing the single central-vertical positioning locating wheel 6/positioning guide track 5 combination with horizontal starboard and port positioning locating wheel 6/positioning guide track 5 combinations at the vehicle 1 leaning angle α position.

Note that whereas in the first and second embodiments, a single central-vertical positioning locating wheel 6/positioning guide track 5 combination defines the vehicle 1's leaning angle α through the full range of swivel pivot 4's swivel pivot angle ϕ's angular range, in this third embodiment, the vehicle 1's leaning angle α definition is divided into port and starboard sectors. The port leaning angle α is defined by the port positioning locating wheel 6/positioning guide track 5 combination while the starboard leaning angle α is defined by the starboard positioning locating wheel 6/positioning guide track 5 combination. FIG. 27 shows the vehicle 1 leaning elements engaged in the starboard sector of the third embodiment.

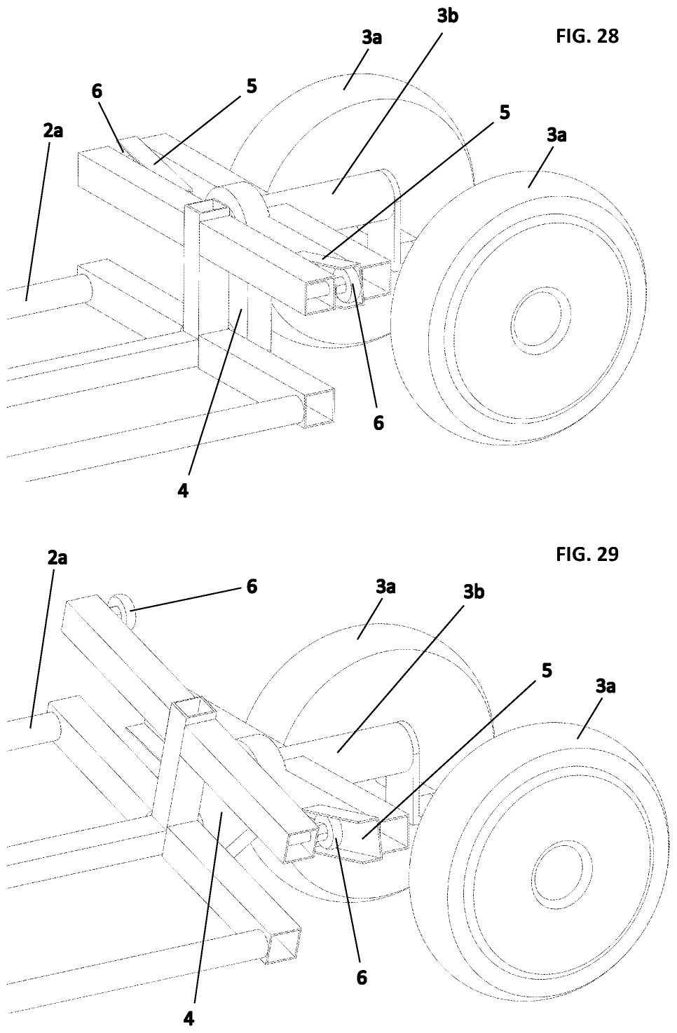

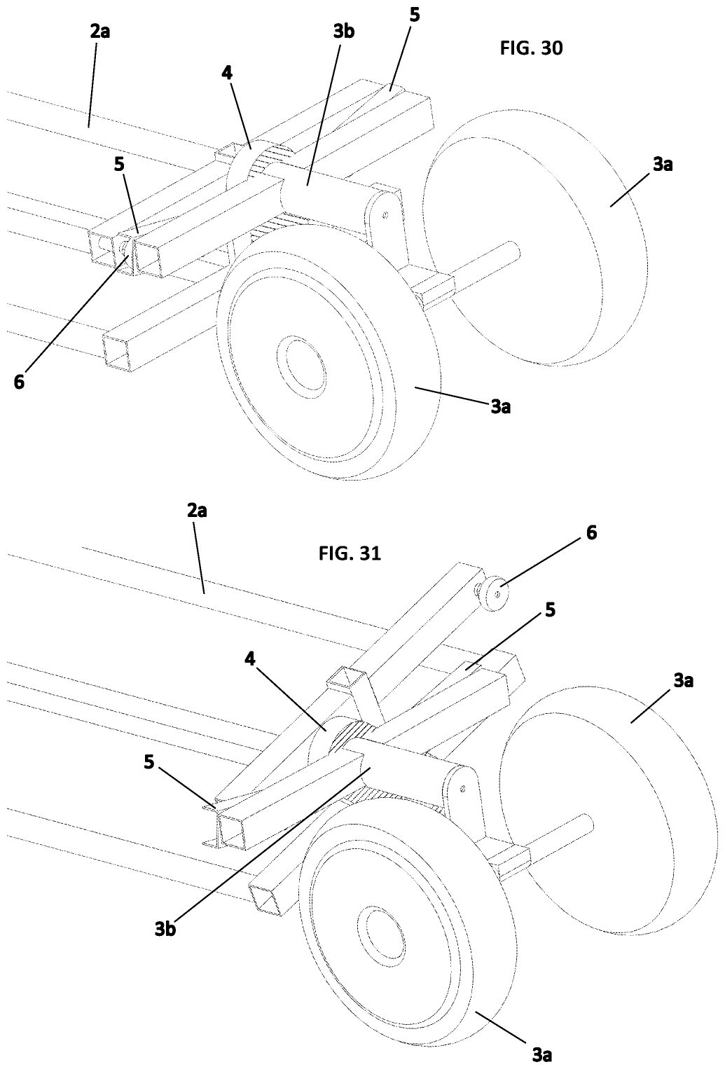

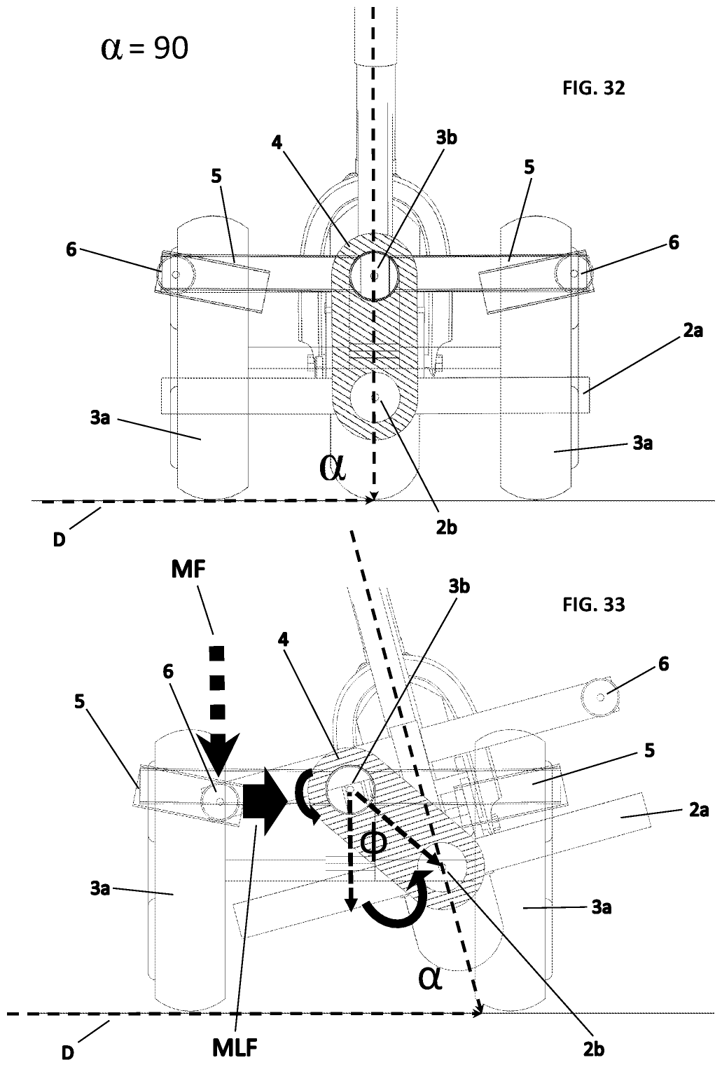

FIGS. 28, 30, and 32 show various views of the fourth embodiment of the present disclosure with the port and starboard positioning guide track 5's of the third embodiment set at a defined angle from the horizontal plane at the upright stable vehicle leaning angle α=90 position.

FIGS. 29, 31, and 33 show various views of the fourth embodiment of the present disclosure with the port and starboard positioning guide track 5's of the third embodiment set at a defined angle from the horizontal plane at the leaning angle α position.

As shown in FIG. 33, angling the position guide track 5's in this fourth embodiment allows the creation of a moment leaning force MLF when a moment force MF is applied on one side (port side shown) of the leaning segment 2 of the vehicle 1. The MLF then causes the swivel pivot 4 to rotate (here counterclockwise) a swivel pivot angle ϕ causing leaning segment 2 into a vehicle 1 leaning angle α as shown.

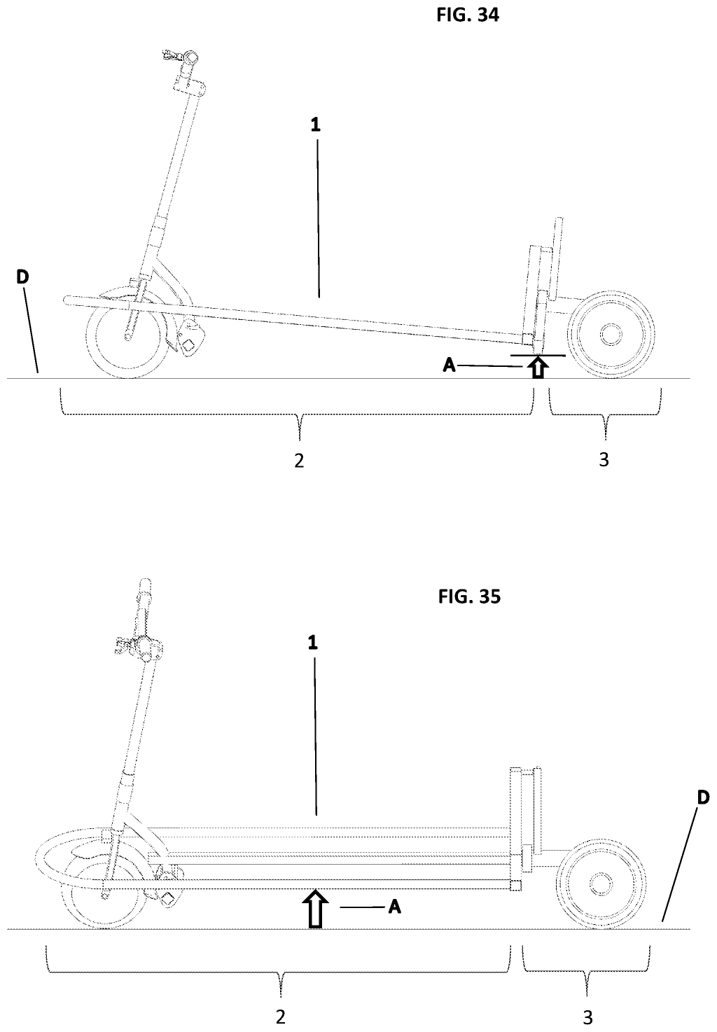

FIG. 34 shows a fifth embodiment where the vehicle 1 is in an angled sloped stance in the upright leaning angle α=90 position (as compared to ground plane D). One of the benefits of this disclosure's leaning system physically lifting the vehicle 1 as it leans is that a constant ground clearance can be maintained along the vehicle 1 underside at the rotation plane of swivel pivot 4 (perpendicular to the longitudinal length of vehicle 1). However, as can be seen in FIG. 9, while a constant ground clearance A can be maintained at the swivel pivot 4 rotation plane and widthwise across vehicle 1, geometrically this cannot be maintained through the entire length of vehicle 1. Therefore, as shown in FIG. 35, giving the vehicle 1 a sloping stance at vehicle 1 leaning angle α=90 will allow it to maintain a constant ground clearance A both widthwise and along its entire length of vehicle 1 at leaning angle α.

What is claimed is:

1. A multi-tracked, segmented vehicle comprising:
a. a leaning body segment that leans to maintain the vehicle stability against vehicle turning forces,
b. a non-leaning body segment that remains level relative to the leaning body segment,
c. a swivel pivot structural member including:
i. a swivel pivot/leaning body segment rotating axis; and
ii. a swivel pivot/non-leaning body segment rotating axis; wherein (i) and (ii) are parallel to each other,
d. one or more positioning guide track means mounted to the non-leaning body segment in a plane perpendicular to one of the swivel pivot rotating axes,
e. one or more positioning locating means mounted to the leaning body segment in a plane perpendicular to the other swivel pivot rotating axis,
f. the vehicle elements are combined to define a kinematic relationship where the leaning body segment is connected to the swivel pivot member via the swivel pivot/leaning body segment rotating axis, the swivel pivot member is connected to the non-leaning body segment via the swivel pivot/non-leaning segment rotating axis, wherein the one or more positioning guide track means is mounted to the non-leaning body segment and engages with the one or more positioning locating means mounted to the leaning body segment,
g. wherein, in a stable upright non-leaning vehicle configuration, the vehicle elements' kinematic relationship permits the vehicle's center of gravity to exert a downward gravitational force to stabilize the vehicle against falling over,
h. wherein, in a dynamic vehicle leaning configuration, artificial moment and/or dynamic forces acting upon the vehicle elements, and in combination with the vehicle elements' kinematic relationship, raises the vehicle's center of gravity height higher than the vehicle's center of gravity height at the upright stable non-leaning vehicle configuration as the vehicle leans, thereby increasing the vehicle's gravitational potential energy,
i. wherein, in the dynamic vehicle leaning configuration, the gravitational potential energy induces a gravitation force torque about the swivel link self-righting the vehicle to the stable upright non-leaning vehicle configuration.

2. The vehicle of claim 1, wherein one or more positioning guide track means mounted to the leaning body segment and one or more positioning locating means mounted to the non-leaning body segment.

3. The vehicle of claim 1, wherein the positioning locating means is replaced by a sliding piston means and the positioning guide track means is replaced by a piston housing means. The sliding piston means and the sliding piston housing means engages and function identically to the positioning locating means and the positioning guide track means.

4. The vehicle of claim 1, wherein the positioning guide track means are angled in a plane perpendicular to the vehicle's longitudinal axis such that a downward force induces a torque about the swivel link to cause the vehicle to lean.

5. The vehicle of claim 1, wherein the vehicle is positioned in an angled standing sloped stance along the vehicle's vertical longitudinal plane in the non-leaning configuration in order to preserve a constant ground clearance along the longitudinal underside length and widthwise of the vehicle when in the leaning configuration.

6. A vehicle substantially as shown in FIG. 8 (dynamic, vehicle leaning configuration—exploded left rear close-up view) showing:
a. the leaning body segment 2,
b. the non-leaning body segment 3,
c. the swivel pivot 4,
d. the positioning guide track means 5, and
e. the positioning locating means 6.
